(19) United States
(12) Patent Application Publication
(10) Pub. No.: US 2008/0017754 A1
(43) Pub. Date: Jan. 24, 2008

(54) Fast-acting, low leak rate active airbag vent

(76) Inventors: Anthony P. Taylor, Huntington Beach, CA (US); Debbie Gardinier, Fountain Valley, CA (US); Michelle Cooper, Santa Ana, CA (US); Robert Sinclair, Costa Mesa, CA (US)

Correspondence Address: JACOBSON HOLMAN PLLC, 400 SEVENTH STREET N.W., SUITE 600, WASHINGTON, DC, 20004, US

(21) Appl. No.: 11/491,071

(22) Filed: Jul. 24, 2006

(51) Int. Cl. B64C 25/56

(52) U.S. Cl. 244/100 A

(57) ABSTRACT

A fast acting and low leak rate vent for an impact landing bag in which a vent hole is covered by a gas barrier assembly having a flexible membrane and a low gas permeability layer. A flap assembly positioned around the gas barrier assembly includes flaps that are movable between an open position in which the membrane is exposed and a closed position in which the flaps cover and reinforce the gas barrier assembly. An externally actuated flow initiator is associated with a fastening element that retains the flaps in the closed position. Upon landing, the flow initiator is activated to sever the fastening element and release the flaps and the low gas permeability layer. Thereafter, the internal pressure within the landing bag under landing forces causes the membrane to burst, releasing a flow of gas from within the landing bag to attenuate impact.

### BACKGROUND OF THE INVENTION

1. Field of the Invention

The present invention is related to the field of landing bag force attenuation and, more particularly, to a vent system and method for a parachute landing bag.

2. Description of the Related Art

Parachute landing bags are well known to those skilled in the art. Such airbags are used to attenuate impact force on the payload upon landing and include an airbag having a control volume of air. Upon impact with the ground, the airbag flattens somewhat to absorb the initial impact, after which a flow of air from the control volume is initiated to continue attenuating the impact.

According to conventional venting approaches, the airbag is provided with one or more pressure-based burst discs as a passive means of initiating flow from the control volume. Such passive systems are activated by a build-up in pressure so as to burst when a threshold pressure inside the airbag has been reached. When employing such a system, care must be taken to ensure that the airbag itself does not rupture before the discs.

Passive venting systems perform very poorly in a variable or uncertain landing envelope in which the necessary pressure may build up too soon or not soon enough, resulting in imprecise venting performance. Therefore, unless a consistent landing condition can be established, the performance of passive venting systems in terms of providing the necessary attenuation for the payload can be compromised.

### SUMMARY OF THE INVENTION

In order to overcome the known problems associated with conventional passive venting systems for landing bags, the present invention provides a system and method for actively controlling the flow of air from an inflatable control volume as embodied in a parachute landing bag. According to the system, a fast acting and low leak rate vent is provided that incorporates a gas barrier assembly and an externally actuated flow initiator that allows for active venting. The gas barrier assembly includes a flexible membrane for sealing a vent opening in the landing bag, and a sheet of low or near zero gas permeability material that covers and provides strength to the membrane. Overlying both the membrane and the sheet are one or more fabric flaps that are secured in a closed position by fastening elements coupled with the flow initiator. To initiate active venting, the flow initiator is externally actuated to release the one or more flaps which, in turn, releases the cover sheet of low permeability material. Thereafter, the internal pressure within the landing bag under landing forces causes the membrane to burst, releasing a flow of gas from within the landing bag.

The flow initiator may be controlled by a device such as an accelerometer that measures the gravity force exerted on the airbag as it impacts the ground and triggers activation of the initiator when a predetermined trigger point is reached. Alternatively, and particularly in an configuration having multiple airbags, initiation of flow from specific airbags may be systematically initiated at various stages of the landing to improve the overall performance.

Accordingly, it is an object of the present invention to provide a fast acting and low leak rate vent for a parachute landing bag.

Another object of the present invention is to provide a fast acting and low leak rate vent for a landing bag that includes an externally actuated flow initiator for affirmative activation of vented air flow, including active initiation at various stages of the landing sequence for improved landing performance.

Still another object of the present invention is to provide a fast acting and low leak rate vent covered by a membrane and a fabric flap, the membrane rupturing to initiate air flow and thereafter being replaceable for reuse of the vent and fabric flap.

A further object of the present invention is to provide a method of constructing a fast acting and low leak rate vent for a landing bag using conventional and commercially available materials.

Yet a further object of the present invention is to provide a method of constructing a fast acting and low leak rate vent for a landing bag that includes covering the vent opening with a membrane, a layer of low permeability material, and a fabric flap, and securing the fabric flap in a closed position covering the vent opening by fastening elements associated with a flow initiator device.

A still further object of the present invention is to provide a method of activating a landing bag vent covered by a membrane and a fabric flap that includes externally actuating a flow initiator that releases the fabric flap, allowing the membrane to expand and burst in response to pressure build-up within the landing bag.

These together with other objects and advantages which will become subsequently apparent reside in the details of construction and operation as more fully hereinafter described and claimed, reference being had to the accompanying drawings forming a part hereof, wherein like numerals refer to like parts throughout. While the drawings are intended to illustrate the invention, they are not necessarily to scale.

### BRIEF DESCRIPTION OF THE DRAWINGS

FIG. 1 shows a cross-sectional view of an airbag vent in accordance with the present invention.

FIG. 2 is a perspective view of an airbag vent such as that shown in FIG. 1, in a pre-deployment readiness configuration.

FIG. 3 shows the airbag vent of FIG. 2 with the flaps pulled back prior to installation of the membrane and gas impermeable disc.

FIG. 4 depicts a textile fabric airbag vent with the flaps closed and secured with a single fastening element in accordance with the present invention.

FIG. 5 depicts the textile fabric airbag vent of FIG. 4 with the flaps closed and secured with multiple fastening elements.

FIG. 6 depicts modification of the flaps to aid in installation of the membrane during construction of the textile fabric airbag vent of FIGS. 4 and 5.

FIG. 7 illustrates a vent opening ready for membrane insertion in accordance with the present invention.

FIG. 8 shows the step of applying adhesive to the membrane to be installed on the vent opening of FIG. 7 with the membrane positioned on a suction tool.

FIG. 9 shows the step of using the suction tool to install the membrane of FIG. 8 onto the vent opening of FIG. 7.

FIG. 10 depicts removal of the suction and the suction tool following the step shown in FIG. 9.

FIG. 11 shows the resulting installed membrane upon completion of the step shown in FIG. 10.

FIG. 12 illustrates the placement of a Spectra disc on the installed membrane of FIG. 11.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

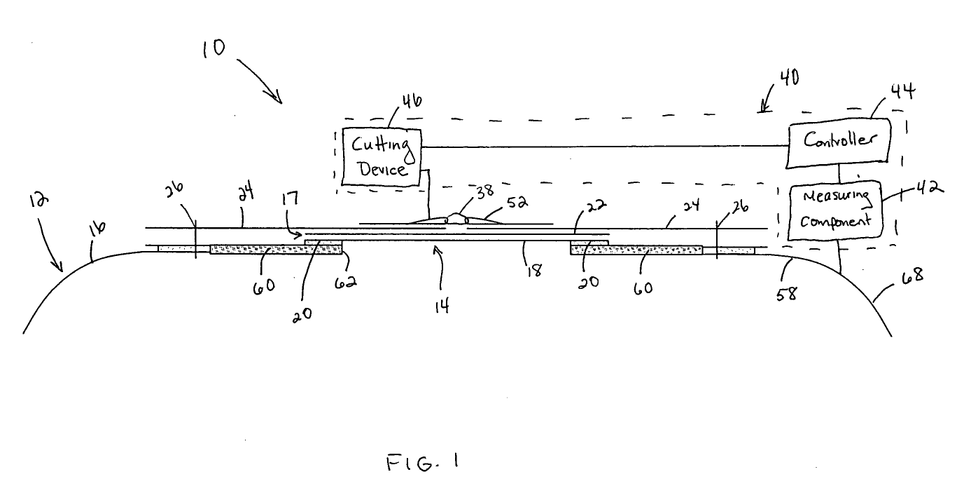

FIG. 1 illustrates a cross-sectional view of a landing bag vent, generally designated by the reference numeral 10, in accordance with the present invention. The vent 10 is formed in an airbag or landing bag, generally designated by reference numeral 12. As used herein, the phrase “landing bag” is intended to include all airbag structures used to attenuate force, whether from landing or other contact conditions in which significant forces are generated. The landing bag described herein is suitable for landing impact attenuation for large payloads including vehicles such as Unmanned Aerial Vehicles (UAVs), unmanned spacecraft, manned spacecraft, etc.

FIG. 2 provides an exterior view of a landing bag 12 with a landing bag vent 10 of the type shown in FIG. 1, in a pre-deployment readiness configuration. The landing bag is typically made of a polyurethane-coated fabric material 78 with strips or lines of Kevlar reinforcement 80 as needed. Silicon may also be used to coat the landing bag fabric.

The vent 10 includes a vent opening 14 formed in the wall 16 of the landing bag 12. Optionally, the vent opening 14 may be reinforced by an orifice reinforcing element 60 which is secured around the perimeter 62 of the vent opening, such as by adhesive. As shown in FIG. 1, this element may be embodied as a single reinforcing layer 60 on the outside surface 68 of the landing bag. If desired, the reinforcing element could include an additional reinforcing layer (not shown) on the inside surface 58 of the landing bag wall as well such that the landing bag wall is sandwiched between the two layers. The reinforcing element 60 strengthens the perimeter 62 and protects the vent opening 14 from tearing during landing.

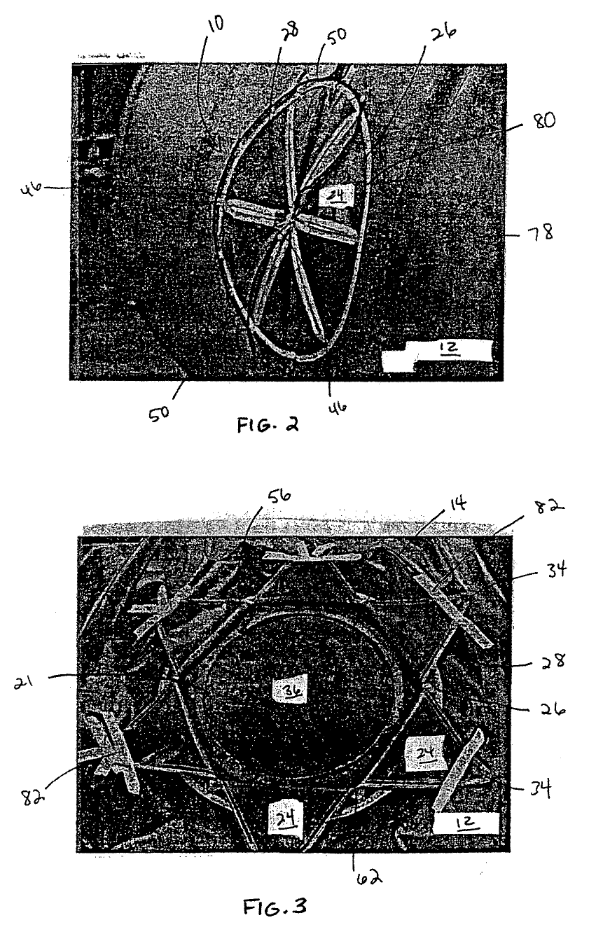

The vent opening 14 is covered by a gas barrier assembly, generally designated by the reference numeral 17. The gas barrier assembly 17 includes a membrane 18 and a layer of low or near zero gas permeability material 22. The membrane spans the opening 14 and is sealed at its edges 20 to an exposed vent perimeter region 21 (see FIG. 3) of the landing bag wall 16. If an orifice reinforcing element 60 is included, the membrane 18 is affixed to the reinforcing element 60 which provides a consistent surface for adherence of the membrane 18. The membrane 18 is preferably made of a material with a low modulus of elasticity so as to provide a sealed closure of the vent opening 14 with limited flexibility for expansion.

Once the membrane 18 is sealed in place, the layer of low or near zero gas permeability material 22 is placed over the membrane 18. Fabrics that have a permeability of less than 5 SCFM/square foot at ½ inch of water pressure are best suited for the present invention. A conventional zero porosity fabric for parachutes is coated with a mixture of polyurethane and silicone and readily available commercially from parachute fabric supplies, such as the “Soar Coat” fabric sold by Performance Textiles of Greensboro, N.C. The specifications for the Performance Textiles “Soar Coat” zero porosity fabric state that it has zero porosity at a differential pressure of 10 inches of water column. Another fabric suitable for the gas barrier assembly of the present invention is referred to as the “F-111” type and is presently available from several sources, including Performance Textiles, and Brookwood Companies, Inc. of New York, N.Y. It is defined in U.S. military specification, MIL-SPECMIL-C-44378. The F-111 type fabric is specified to have a permeability between zero to 5 SCFM at ½ inch water pressure.

According to a preferred embodiment, the low or zero gas permeability layer is made of Spectra cloth or Vectran. Spectra is light in weight and relatively strong, with a “slick” surface that is well suited to protection of the membrane 18. The Spectra layer 22, which is not attached to the membrane 18 but is merely placed thereon, controls the expansion of the membrane 18 and also evenly distributes the load thereon during airbag inflation.

The Spectra layer 22 is generally cut in the shape of a disc and is placed over the membrane 18. For ease of reference, this component is hereafter referred to as “Spectra disc” 22 with the understanding that the precise shape and exact material is not necessary to the proper functioning of the invention. Other materials having similar structural and gas permeability characteristics, such as those identified above, and cut or otherwise formed to have other shapes could also be used.

The membrane 18 and Spectra disc 22 are covered by at least one flap 24 that is secured, preferably by sewing, to the wall 16 of the landing bag 12 along at least one flap edge 26. The free portion 28 of the flap 24 is able to move between an open position in which the free portion 28 is pulled back toward the secured flap edge 26 to expose the vent opening 14 as shown in FIG. 3, and a closed position in which the free portion 28 is laid flat to at least partially cover the vent opening 14 and gas barrier assembly 17 as shown in FIG. 2. With the flap in the closed position, the Spectra layer 22 is loosely secured in place by an adhesive such as a piece of fiberglass tape.

In the preferred embodiments shown in FIGS. 2-4, the vent 10 includes a flap assembly generally designated by reference numeral 30 having a plurality of pie-wedge-shaped flaps 24 extending inwardly from the secured flap edges 26 which form a generally circular perimeter 32 around the vent opening 14. In the closed position shown in FIG. 2, each flap 24 covers only a wedge-shaped portion of the vent opening 14, with the tips 34 of all of the flaps 24 meeting or nearly approaching one another in the center 36 of the vent 10. Conversely, in the open position shown in FIG. 3, the flaps 24 can be folded back to overlap their respective secured edges 26 affixed to the landing bag 12. While the embodiment shown in FIGS. 2 and 3 is preferred, it is also possible to cover the vent opening 14 with a single flap, such as a rectangular component that would cover the vent opening like a tent flap.

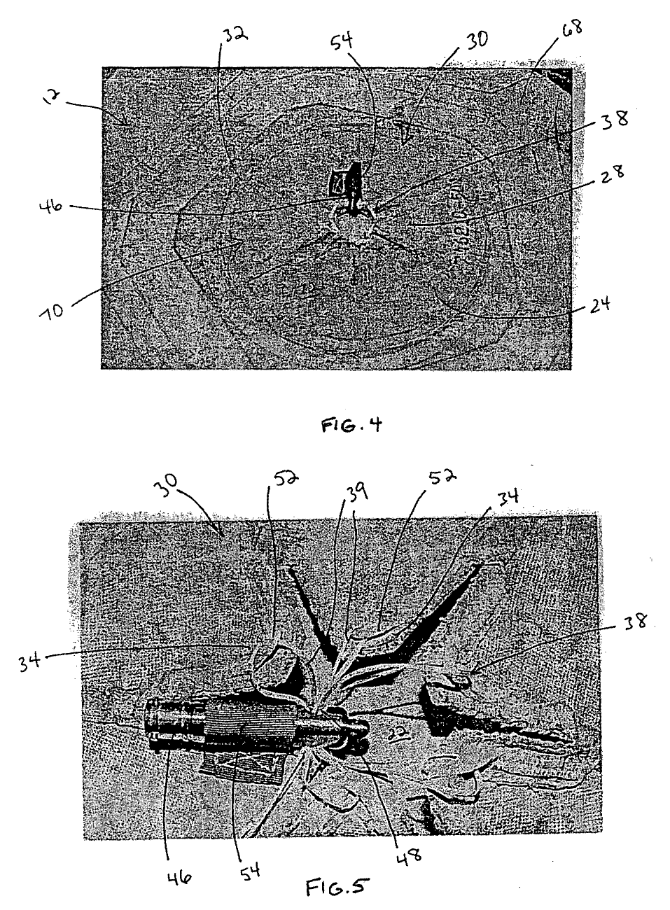

With the flaps 24 in their closed position, a fastening element generally designated by reference numeral 38 is used to secure the flap tips 34 together as shown in FIGS. 4 and 5. The fastening element 38 is associated with an externally activated flow initiator, generally designated by the reference numeral 40, that, when activated, severs the fastening element 38 to release the flap tips 34.

The externally activated flow initiator 40 includes a measuring component 42, a controller 44 and a cutting device 46. The measuring component 42 may be embodied as an accelerometer that measures the force exerted by gravity, or the “gee” level, on the landing bag 12. When the gee level reaches a predetermined trigger point, the controller 44, which may be embodied as an onboard sequencer, sends a signal to activate the cutting device 46.

The fastening element 38 may be embodied as one or more ties or cords 39, while the cutting device is embodied as a conventional electrical or pyro-initiated cutter 46 known to those skilled in the art. At least one portion of the cord 39 is threaded through an opening 48 in the cutting device 46. Upon activation thereof, the cutting device 46 severs the portion of the cord 39 threaded through the opening 48 to release the flap assembly 30 and allow the flaps 24 to move to the open position. According to the preferred embodiment shown in FIG. 2, two such cutting devices 46 are included in the routing of the cord, with each cutter having its own activation wire 50, so as to act as redundant flow initiators 40.

As shown in FIGS. 4 and 5, each flap tip 34 is provided with a loop 52 through which the fastening element 38, preferably a spectra cord 39, is passed. Each flap tip may be secured with a direct line connection to the cutting device such that the fastening element is routed back and forth from each of the flap tips back to the cutting device, as shown in FIG. 5. Alternatively, the fastening element may be serially threaded through each of the flap loops to interconnect all of the flap tips before passing through the cutting device at only one point, in the manner shown in FIG. 4. The back and forth routing configuration shown in FIG. 5 is preferred as activation of the cutting device cuts the cord 39 in multiple places. This latter configuration immediately releases all of the flaps with no need for the cord 39 to have to slip back through each of the loops 52 in series as is required in the configuration shown in FIG. 4. In both embodiments, a preferred material for the cord 39 is Spectra which, because of its smooth surface, aids in removal of the fastening element from the loops upon vent actuation.

As also shown in FIGS. 4 and 5, the cutting device 46 of the flow initiator 40 is preferably secured against the flap assembly 30 by a sleeve 54 secured to one of the flaps 24. While the sleeve 54 is shown as being generally cylindrical, other shapes could also be used as needed to accommodate other cutting devices.

In use, the relatively low modulus membrane 18 acts as a gas barrier, while the Spectra disc 22 which is placed over the membrane controls the expansion of the membrane and also evenly distributes the load on the membrane 18 during airbag inflation. As the landing bag 12 is inflated to design pressures, the membrane expands, transfers the load to the disc 22 which, in turn, subsequently transmits the load to the flaps 24. Upon impact with the ground, the accelerometer 42 measures the gee level on the landing bag and, when the level reaches the predetermined trigger point, the controller 44 signals the firing of the cutting device 46 to cut the ties 39 holding the flaps in their closed position. Once the flaps are free to open, the Spectra disc 22 flies off and the internal pressure in the landing bag causes the membrane 18, now unsupported by the disc and the flaps, to burst, releasing the gas inside the bag.

If there are multiple airbags, actuation of the vents in the respective bags can be set to happen at the same time on all airbag vents or can be set to occur at different times, i.e., pressures, depending on the desired performance required of each airbag. As an example of the latter, in the case of two airbags, the trigger point of the vent in the first airbag may be set to occur at a lower gee level than the trigger point of the vent in the second airbag so that the first vent is opened earlier than the second, i.e., the forward bag has a different trigger gee than the aft bag.

The force required to break the membrane 18 is a function of the size of the vent 10 and the material from which it is made. A preferred material for the membrane is latex, although nylon or rubber could also be used. The latex material is an off-the-shelf component and can be purchased in varying thicknesses. The best thickness will depend upon the intended application of the landing bag and the area or diameter of the vent. The number of vents in a given airbag is also a consideration, as the presence of multiple vents in the landing bag will typically change, e.g., reduce, the desired size of each of the vents such that the total vent area is not increased. For example, if an airbag has a vent of a certain diameter defining a vent area A, if that vent is to be split into two vents, each vent is made smaller so that the total vent area A remains substantially the same.

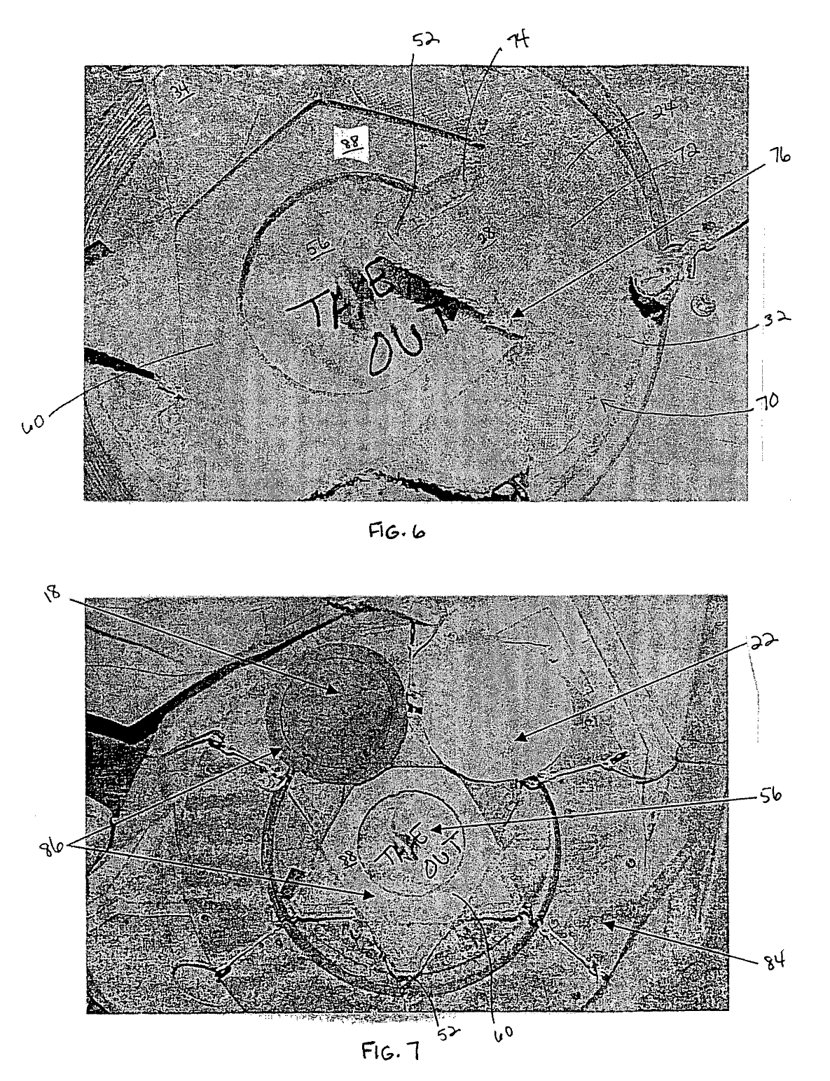

A method for constructing the vent according to the present invention, is set forth in various stages in FIGS. 3-12. First, a precision-cut hole is made in the landing bag to form the vent opening 14 as shown in FIG. 3. Once the vent opening 14 is made, and prior to the subsequent steps of gluing as will be hereinafter described, a removable disk 56 (see FIGS. 6 and 7) may be temporarily inserted on the inside surface 58 of the landing bag 12 to protect the inside of the landing bag from contact with the adhesives. An orifice reinforcing element 60 may also be secured around the perimeter 62 of the vent opening, if desired.

After the orifice reinforcing element is installed, if such element is included, the flap assembly 30 having a plurality of flaps 24 is attached to the exposed vent perimeter 21 on the outside surface 68 of the landing bag wall around the vent opening. As can be seen in FIG. 6, the flap assembly may be embodied as a generally circular fabric component generally designated by reference numeral 70 formed through the joinder of a plurality of pie-shaped wedges 72. The flaps 24 are secured to one another around the circumference 32 of the assembly 30, but are unattached at their inward tips 34 such that they can be folded back toward the circumference 32 as shown. If the free portion 28 of the flaps is not large enough, part of the side seams 74 joining adjacent flaps may be cut an additional distance, as indicated at 76 in FIG. 6, to aid in proper installation of the membrane. The generally circular fabric component 70 is preferably sewn onto the airbag fabric, although other attachment methods could be used if and as appropriate.

Rather than textile fabric 70 as shown in FIG. 6, the flaps can be constructed of the polyurethane-coated airbag fabric 78 itself, with a Kevlar reinforcement pattern 80 around the edges as shown in FIG. 2. Flaps with this construction may be affixed to the airbag material by sewing or through a combination of a weld and a stitching pattern. In forming the weld, heat and pressure are applied to the joint until the polyurethane coating on the two fabric articles fuses.

Preparatory to installing the gas barrier assembly 17, the flaps 24 are folded back to their open position as shown in FIGS. 3 and 7. The flaps can be secured with tape 82, as shown in FIG. 3, or a flap retention tool 84 may be used such as that shown in FIG. 7. The flap retention tool 84 is preferred as it is not susceptible to unexpected release of one or more flaps 24 as can occur with tape 82.

A vent opening 14 ready to receive the gas barrier assembly 17, as well as the membrane 18 and Spectra disc 22 to be inserted, are shown in FIG. 7. The membrane 18 is installed using an adhesive 86. When using a two-part adhesive, the first component is applied to the outer surface 88 of the reinforcing element and, as shown in FIG. 8, the second component of the adhesive 86 is applied to the membrane 18.

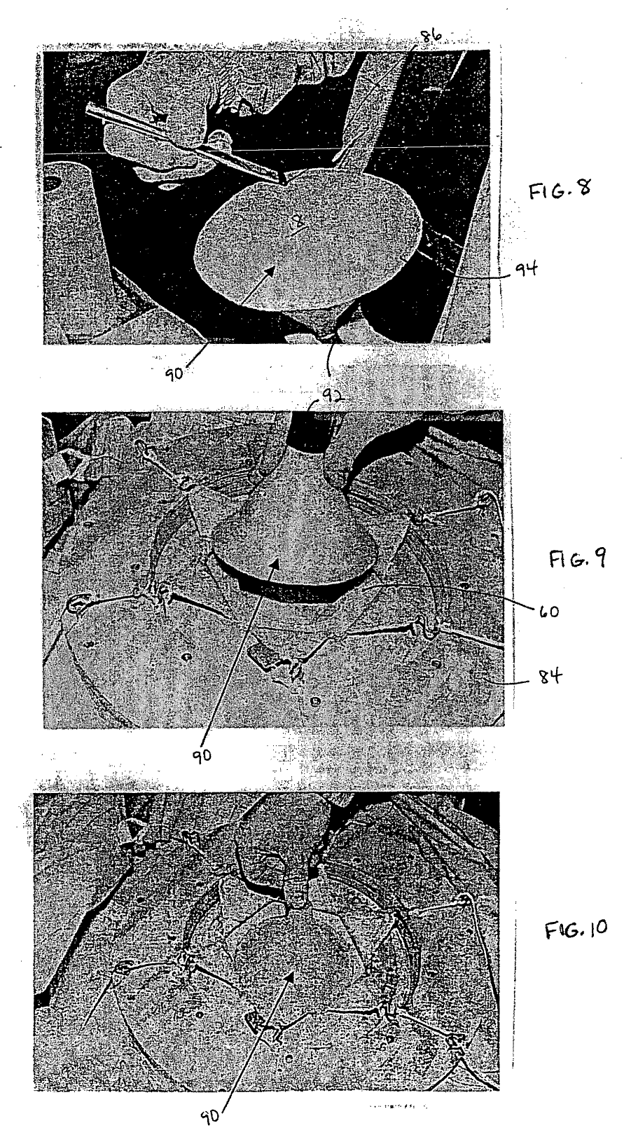

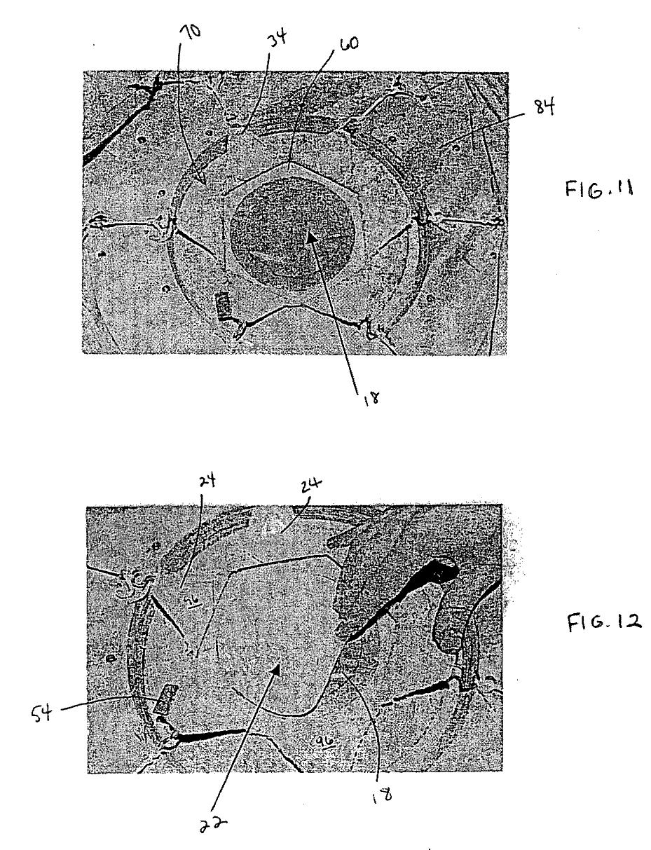

To facilitate application of the adhesive 86 to the membrane 18, a suction tool 90 having a hose 92 for drawing in air may be used which pressurizes the membrane 18 against a fine wire mesh 94 to ease the manipulation of the membrane material. Once the adhesive 86 has been activated, the membrane as held by the tool 90 is pressed against the exposed vent perimeter 21, or the reinforcing element 60 if present, as shown in FIG. 9. Once the adhesive has set, the suction is removed, FIG. 10, leaving the membrane installed as shown in FIG. 11.

After the adhesive has been given time to fully cure, a Spectra disc 22 is placed over the membrane 18 as shown in FIG. 12. As the disc is not attached to the membrane 18, an adhesive material such as double-sided tape is preferably provided on the interfacing surface 96 of one or more of the flaps 24 to loosely secure the disc in place during packing and deployment of the landing bag. According to a preferred embodiment, the Spectra disk is secured to only one flap.

Closure of the vent opening is completed by securing the tips 34 of the flaps to one another and/or to the cutting device 46 of the flow initiator 40 as shown in FIGS. 2, 4 and 5. In both the fabric embodiment of FIGS. 4 and 5, and the Kevlar reinforced pattern on the polyurethane-coated airbag fabric of FIG. 2, the fastening element or cord 39 is threaded through the loops 52 on the tips 34 of the flaps as shown in FIG. 5. Threading the cord in this manner ensures that no cord 39 will become caught in the loops 52.

When deployed, the relatively high modulus of the flap assembly 30 as secured by the fastening element 38 in the closed position carries the majority of the inflation load. Once the vent 10 is opened by the externally actuated flow initiator 40 and the Spectra disc 22 released, the membrane 18 will expand and burst to provide the desired landing performance. The vent 10 may thereafter be refurbished by replacing the membrane, allowing for reuse of the landing bag 12.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A vent system for a landing bag comprising:
a vent opening in a wall of said landing bag;
a gas barrier assembly including a first layer of a low modulus material sealed to the wall around said vent opening so as to close said vent opening, and a second layer of a low gas permeability material placed over said first layer;
at least one flap having a closed position substantially covering said gas barrier assembly, and an open position in which said first layer alone covers said vent opening;
a fastening element securing said flap in said closed position; and
a flow initiator associated with said flap and said fastening element which, when activated during deployment, releases said fastening element to allow said flap to move from said closed position and to allow said first layer to burst in response to pressure build-up in said landing bag upon landing.

2. The vent system as set forth in claim 1, wherein said first layer is a latex membrane.

3. The vent system as set forth in claim 1, wherein said second layer is made of Spectra fabric.

4. The vent system as set forth in claim 3, wherein said second layer is held against said first layer by said flap when in said closed position, movement of said flap to said open position releasing said second layer.

5. The vent system as set forth in claim 1, wherein said at least one flap includes a plurality of flaps arranged in a generally circular flap assembly affixed to said landing bag around a circumference thereof, each flap forming a pie-shaped wedge of said flap assembly with a tip thereof being movable between said open and closed positions.

6. The vent system as set forth in claim 5, wherein said fastening element engages the tips of said plurality of flaps in said closed position.

7. The vent system as set forth in claim 6, wherein said fastening element includes a cord and said flap tips are each provided with a loop construction through which the cord is threaded.

8. The vent system as set forth in claim 7, wherein said flow initiator, when activated, cuts said cord to allow said flaps to move into the open position.

9. The vent system as set forth in claim 1, further comprising a reinforcing element between the wall of the landing bag and the gas barrier assembly.

10. A method of fabricating a vent system for a landing bag comprising:
making a hole in the landing bag to form a vent opening therein;
affixing a flap assembly to said landing bag wall so as to encircle said vent opening while leaving an exposed vent perimeter, said flap assembly having a closed position substantially covering said vent opening and an open position in which said vent opening is exposed;
adhering a low modulus membrane to the exposed vent perimeter around said vent opening so as to sealingly close said vent opening;
placing a low gas permeability element over said membrane; and
securing said flap assembly in said closed position prior to deployment of said landing bag.

11. The method as set forth in claim 10, wherein said flap assembly includes a plurality of flaps arranged in a generally circular configuration and is affixed to said landing bag around a circumference of said assembly, each flap forming a pie-shaped wedge of said assembly with a tip thereof being movable between said open and closed positions, said step of affixing said flap assembly including moving said flaps to said open position prior to adhering said membrane to said exposed vent perimeter.

12. The method as set forth in claim 11, wherein said step of securing said flap assembly in said closed position includes:
threading a fastening element through loop elements on said flap tips; and
associating said fastening element with a flow initiator operative to sever said fastening element following deployment of said landing bag.

13. The method as set forth in claim 12, wherein said step of threading the fastening element includes alternatingly passing said fastening element through each of said loop elements and through an opening in a cutting device of said flow initiator so that said fastening element is associated with said cutting device at a plurality of points.

14. The method as set forth in claim 11, wherein said step of placing said low gas permeability element includes securing said element to an underside of at least one of said flaps.

15. The method as set forth in claim 14, wherein said step of securing said low gas permeability element includes adhering said element to said at least one flap with an adhesive.

16. The method as set forth in claim 10, wherein said step of making a hole includes affixing a reinforcing element around the exposed vent perimeter, said low modulus membrane being affixed to said reinforcing element.

17. The method as set forth in claim 11, wherein said step of adhering said membrane includes:
applying adhesive to said exposed vent perimeter;
grasping said membrane using a suction tool having vacuum pressure;
pressing the suction tool with the membrane held thereon by said vacuum pressure against the exposed vent perimeter until the adhesive is fixed; and
releasing said vacuum pressure to remove said tool.
